(19) United States
(12) Patent Application Publication
(10) Pub. No.: US 2008/0253771 A1
(43) Pub. Date: Oct. 16, 2008

(54) Method and apparatus for configuring Optical Network Terminals (ONT) in a network

(76) Inventors: Jeffrey A. Noel, Leesburg, VA (US); Nabeel Zafar, Woodbridge, VA (US); Joseph D. Kralowetz, Clarksville, MD (US); Wen-Bing Shiu, Potomac Falls, VA (US); John A. Stock, Leesburg, VA (US); Marc R. Bernard, Miramar, FL (US); Shih-Chang Liang, Rockville, MD (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/804,574

(22) Filed: May 18, 2007

Related U.S. Application Data
(60) Provisional application No. 60/923,429, filed on Apr. 13, 2007.

(51) Int. Cl. H04J 14/00

(52) U.S. Cl. 398/67

(57) ABSTRACT

A method and system allowing a network operator to change services on a large group of Optical Network Terminals (ONTs) at one time through the use of profiles. At least one profile is configured, and at least one of the profiles is associated with at least one Optical Network Terminal (ONT) having a number of ports. A configuration for the ONTs is generated based on the profiles and, upon a request by an ONT, the configuration is forwarded to the requesting ONT. The method and system may include a graphical user interface (GUI) for entering information used in configuring the profiles, and may assign the profiles to multiple ONTs. Further, the GUI may automatically gather and provide statistics relating to the ONTs to the network operator. Additionally, in a Session Initiation Protocol (SIP) network, the method and system may communicate with the ONTs without using a SIP protocol stack.

### RELATED APPLICATION

This application claims the benefit of U.S. Provisional Application No. 60/923,429, filed on Apr. 13, 2007. The entire teachings of the above application are incorporated herein by reference.

### BACKGROUND OF THE INVENTION

An Optical Network Terminal (ONT) uses ONT operating parameters to operate in a Passive Optical Network (PON). Examples of ONT operating parameters include parameters for ATM Adaptation Layer Type 1 (AAL 1)/Session Initiation Protocol (SIP) mode, Ground Start/Loop Start mode, and video administrator state. In general, SIP creates, modifies, and terminates sessions, such as Internet telephone calls, multimedia distribution, and multimedia conferences, with one or more participants, as standardized by Request for Comments (RFC) 3261, entitled, “Session Initiation Protocol,” J. Rosenberg, et al., June 2002.

### SUMMARY OF THE INVENTION

Currently, the Independent Operating Company (IOC) market does not have an efficient method for configuring Optical Network Terminals (ONTs) in a network, such as, for example, a Session Initiation Protocol (SIP) network. A method and system according to an example embodiment of the present invention is provided that allows a network operator to change services on a large group of Optical Network Terminals (ONTs) in a network at one time through the use of profiles.

According to one embodiment, at least one profile defining internode communications between nodes in a network is configured, and at least one of the profiles is associated with at least one ONT having at least one port to support internode communications between the at least one ONT and another node in the network. A configuration for the at least one ONT is generated based on the at least one profile associated with the at least one ONT, and is forwarded to at least one of the ONTs in response to a request from the at least one ONT.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example Passive Optical Network (PON).

FIG. 2 is a block diagram illustrating an Optical Network Terminal (ONT).

FIG. 3A-B are network diagrams illustrating embodiments of the present invention.

FIG. 3C is a flow chart illustrating an embodiment of the present invention.

FIG. 3D is a block diagram illustrating an embodiment of the present invention.

FIG. 4 is a block diagram illustrating an example Optical Network Terminal (ONT) database structure for the database of FIG. 3A.

FIG. 5 is a block diagram illustrating an example Optical Network Terminal (ONT) model database structure for the database of FIG. 3A.

FIG. 6 is a flow chart illustrating configuring Optical Network Terminals (ONTs), profiles, and ONT models.

FIG. 7 is a flow chart illustrating configuring Optical Network Terminals (ONTs).

FIG. 8 is a flow chart illustrating configuring Optical Network Terminal (ONT) ports.

FIG. 9 is a diagram illustrating an example interface screen used to configure Optical Network Terminal (ONT) models.

FIG. 10 is a diagram illustrating an example interface screen used to configure profiles.

FIG. 11 is a diagram illustrating an example interface screen used to create and modify Optical Network Terminal (ONT) configurations.

FIG. 12 is a diagram illustrating an example interface screen displaying a summary of configured Optical Network Terminals (ONTs).

### DETAILED DESCRIPTION OF THE INVENTION

A description of example embodiments of the invention follows.

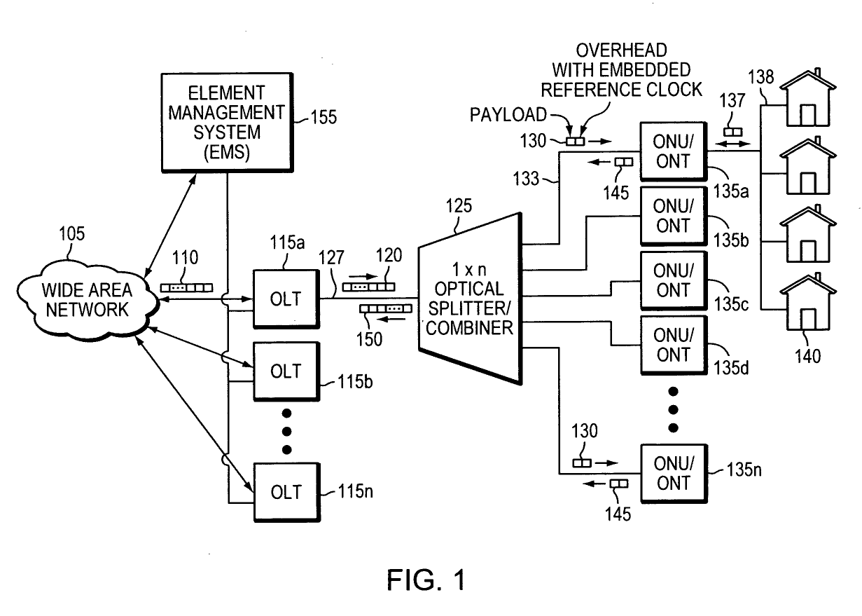

FIG. 1 is a network diagram of a passive optical network (PON) 100 illustrating aspects of an example embodiment of the invention. The network includes at least one optical line terminal (OLT) 115a-115n, an Element Management System (EMS) 155, an optical splitter/combiner (OSC) 125, and at least one optical network unit (ONU) or optical network terminal (ONT) 135a-135n (hereinafter both referred to as ONT). Data communications 110 may be transmitted between the OLTs 115a-115n and a wide area network (WAN) 105.

Communication of data transmitted between a given OLT 115a and its associated ONTs 135a-135n may be performed using standard communication protocols known in the art. For example, point-to-multipoint (e.g., broadcast with IDs of intended recipients) for transmitting downstream data from the OLT 115a to the ONTs 135a-135n and point-to-point for transmitting upstream data from an individual ONT 135a-135n back to the OLT 115a (e.g., time division multiple access (TDMA)).

The PON 100 may be deployed for fiber-to-the-premise (FTTP), fiber-to-the-curb (FTTC), fiber-to-the-node (FTTN), and other fiber-to-the-x applications. The optical fiber 127, 133 in the PON 100 may operate at bandwidths such as 155 Mb/sec, 622 Mb/sec, 1.25 Gb/sec, and 2.5 Gb/sec or any other desired bandwidth implementation. The PON 100 may incorporate asynchronous transfer mode (ATM) communications, broadband services such as Ethernet access and video distribution, Ethernet point-to-multipoint topologies, native communications of data and time division multiplex (TDM) formats, and other communications suitable for a PON. Customer premise equipment (e.g., inside homes 140) that can receive and provide communications in the PON 100 may include standard telephones (e.g., PSTN and cellular), Internet Protocol telephones, Ethernet units, video devices, computer terminals, digital subscriber line connections, cable modems, wireless access, as well as any other conventional customer premise equipment.

The OLT 115a generates or passes through downstream communications 120 to an OSC 125. After passing through the OSC 125, the downstream communications 130 are broadcast to the ONTs 135a-135n, where each ONT 135a-135n reads data 130 intended for that particular ONT 135a-135n using, for example, identification information embedded within the communications signal. Data communications 137 may be further transmitted to and from, for example, a user's home 140 in the form of voice, data, video, and/or telemetry over copper, fiber or other suitable connection 138 as known to those skilled in the art. The ONTs 135a-135n transmit upstream communication signals 145 back to the OSC 125 via fiber connections 133. The OSC 125, in turn, combines the ONT 135a-135n upstream communications signals 145 and transmits the combined signals 150 back to the OLT 115a using, for example, a TDM protocol. The OLT 115a may further transmit the communication signals 110 to the WAN 105.

Communications between the OLT 115a and the ONTs 135a-135n occur using a downstream wavelength and an upstream wavelength. The downstream communications from the OLT 115a to the ONTs 135a-135n may be provided at, for example, 622 megabytes per second, which is shared across all ONTs. The upstream communications from the ONTs 135a-135n to the OLT 115a may be provided, at for example, 155 megabytes per second, which is shared among all ONTs 135a-135n connected to the OSC 125.

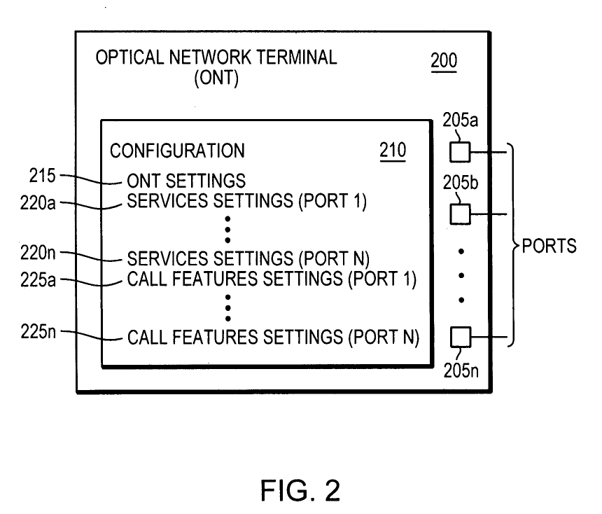

FIG. 2 is a block diagram illustrating an Optical Network Terminal (ONT) 200, according to an embodiment of the present invention. Optical Network Terminals (ONTs) use settings or operating parameters to enable one or more communications services between an Optical Line Terminal (OLT) 115 (FIG. 1) and an ONT 135 (FIG. 1). Such settings are stored in the ONT 200 as a configuration 210 and may be updated by specifying a new configuration in a format such as Extensible Markup Language (XML). The configuration 210 includes global settings (or ONT settings) 215, and, for each port 205a-205n of the ONT 200, Services settings 220a-220n and Call Features settings 225a-225n.

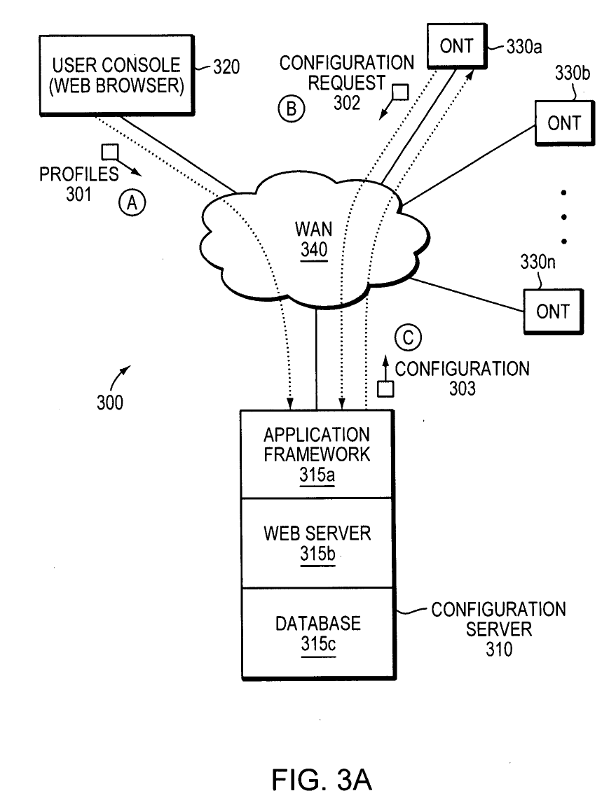

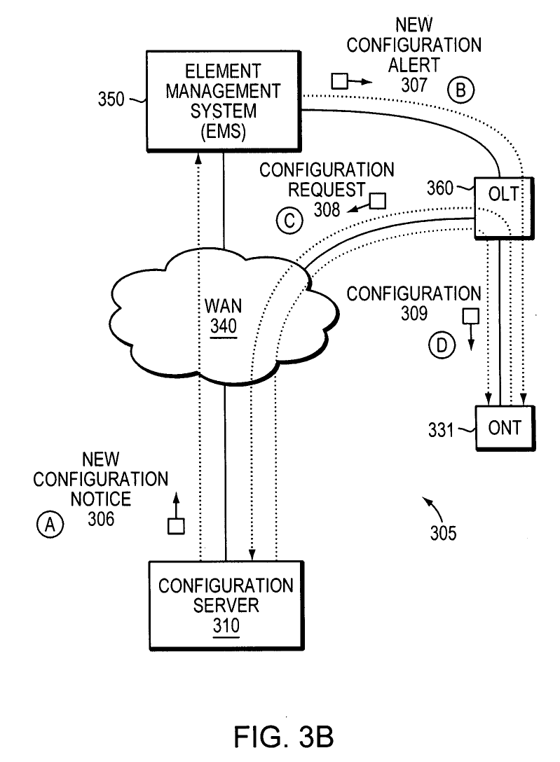

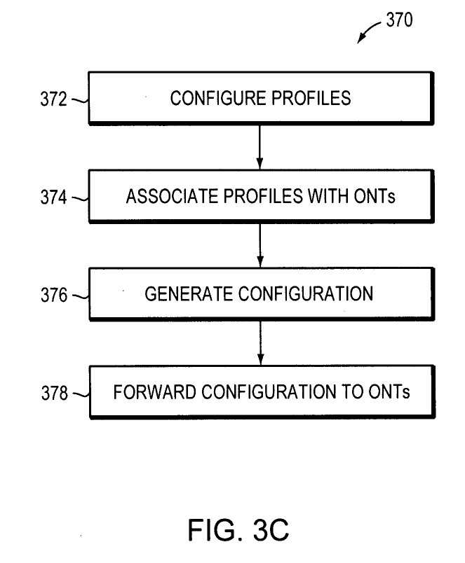

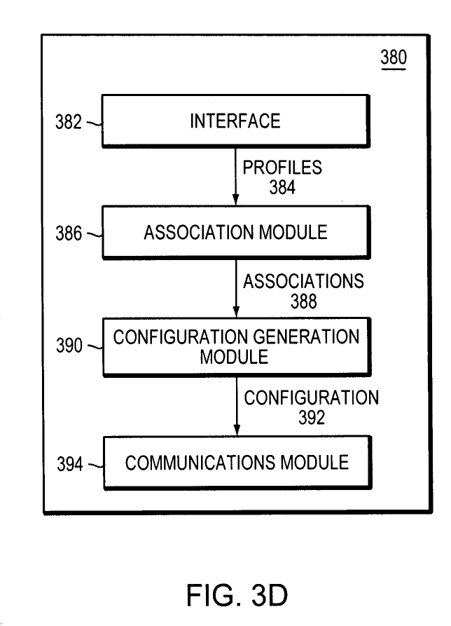

FIG. 3A is a network diagram 300 illustrating an embodiment of the present invention. The Independent Operating Company (IOC) market currently does not have an efficient way to configure Optical Network Terminals (ONTs) 330a-330n in a network, such as a Session Initiation Protocol (SIP) network. Network operators need to configure settings, such as SIP parameters in the case of a SIP network, on an ONT in a convenient and secure fashion; therefore, a user-friendly system including a graphical user interface (GUI) would be useful for managing a database of settings, such as SIP configuration parameters for use in a SIP network, and for enabling the ONTs 330a-330n to request those configuration settings securely over the general Internet 340.

One approach to this problem involves sending XML pages to an ONT to configure SIP parameters; however, such an approach requires using a SIP protocol stack to operate with the ONTs, which must be licensed at a very large cost. Another approach involves a trivial file transfer protocol (TFTP) method of serving predefined XML pages to the ONTs; however, this approach does not make use of a convenient graphical user interface and is not easily modified for different configurations.

The present method and apparatus overcome the problems associated with the above approaches and allows a network operator to change services on a large group of ONTs 330 at one time through the use of profiles 301. Such profiles 301 are created for users in the network, and for each profile, a single profile is saved in a database 315c, and assigned to multiple ONTs 330. The profile is then propagated to all of the ONTs 330 to which it is assigned. In embodiments that involve configuring ONTs in a SIP network, the ONTs may be configured without use of the SIP protocol stack.

The profiles may include at least one settings profile, at least one services profile, and at least one call features profile. Further, one of the settings profiles, at least one of the services profiles, and at least one of the call features profiles may be associated with the at least one ONT. Additionally, one of the services profiles and one of the call features profiles may be associated with each port of the at least one ONT. It should be noted that at least one of the profiles may be associated with fewer than all of the ONTs.

At least one of the profiles associated with the ONTs may include a polling timer setting, and the ONTs may request configurations based on the polling timer setting. It should be noted that the polling timer setting may specify a time window in which the ONTs may randomly request their configurations. Additionally, the ONTs may request their configurations in response to a “new configuration” alert.

In one embodiment, a system includes an interface to configure at least one profile defining internode communications between nodes in a network, an association module that associates at least one of the profiles with at least one Optical Network Terminal (ONT), a configuration generation module that generates a configuration for the at least one ONT based on the at least one profile associated with the at least one ONT, and a communication module that forwards the configuration to at least one of the ONTs in response to a request from the at least one ONT. It should be noted that each of the ONTs has at least one port to support internode communications between the at least one ONT and another node in the network. Additionally, the system may include an Element Management System (EMS) that alerts the ONTs when a new configuration is available.

In another embodiment, a network includes an interface to configure at least one profile defining internode communications between nodes in a network, and a server that associates at least one of the profiles with at least one optical network terminal, generates a configuration for the at least one ONT based on the at least one profile associated with the at least one ONT, and forwards the configuration to at least one of the ONTs in response to a request from the at least one ONT. As above, it should be noted that each ONT has at least one port to support internode communications between the at least one ONT and another node in the network. Additionally, the interface may be a web browser and the server may include a web service.

In yet another embodiment, an optical network terminal (ONT) includes at least one port to support internode communications between the ONT and another node in a network, and a configuration based on at least one profile defining internode communications between nodes in the network. The ONT also includes a polling mechanism that requests new configurations. The polling mechanism may request configurations based on a timer setting within the configuration, and may request new configurations randomly within a specified window of time.

In an example embodiment, the present invention includes a Configuration Server 310 and a user console (interface) 320. The Configuration Server 310 runs an operating system (such as Linux) and may include three major components: an Application Framework 315a (such as Ruby on Rails), a Web Server 315b (such as Apache), and a Database 315c (such as MySQL).

A user of the system can modify ONT configurations (or profiles) 301 through the interface 320, which may be a web browser in the example embodiment. According to the example embodiment, the profiles 301 are stored in the database 315c of the Configuration Server 310 and are used by the Configuration Server 310 to generate an XML file that is ultimately retrieved by at least one ONT 330. The generated XML file includes two parts: a global ONT configuration, or ONT settings (such as a transport protocol including a name, port number, and a DSCP value), and per-port, User Agent (UA), configurations (such as an Address of Record (AOR), realm, username, and password). It should be noted that the ONT 330 receives two files from the Configuration Server 310: the XML configuration file and a “trust-anchor” file that includes a certificate for a Proxy Server.

During ONT operation, an ONT 330 may send a request 302 to the Configuration Server 310 asking for the configuration associated with the ONT. The ONT 330 specifies in the request its Dynamic Host Configuration Protocol (DHCP) Client Identifier (its unique ONT name) as a Uniform Resource Identifier (URI) so the Configuration Server 310 may return the appropriate configuration 303 (e.g., in the form of an XML file) to the ONT 330. This polling of the Configuration Server 310 by the ONTs 330 results in less stress on the Configuration Server 310, and reduces the complexity of any software involved. It should be noted that the configuration 303 sent to the ONT 330 may be dynamically created upon the request by the ONT 330 for its configuration.

FIG. 3B is a network diagram 305 illustrating an embodiment of the present invention. In the example embodiment, an Element Management System (EMS) 350 notifies an ONT 331 of a new configuration. Typically, an ONT 331 will periodically poll the Configuration Server 310 for its configuration (e.g., every 24 hours); however, an ONT 331 may be notified of the existence of a new configuration so that the ONT 331 may immediately send requests for its updated configuration.

In this case, when a new configuration is available, the Configuration Server 310 sends a notice 306 of the new configuration to the EMS 350. Upon receiving the notice 306 from the Configuration Server 310, the EMS 350 sends an alert 307 regarding the new configuration to an OLT 360, which passes the alert 307 along to at least one associated ONT 331. When the ONT 331 receives the alert 307, it may then send a configuration request 308 to the Configuration Server 310. Upon receipt of the request 308, the Configuration Server 310 then sends the ONT's configuration 309 to the ONT 331.

The global configuration of an ONT 331 (ONT Settings) allows configuration of a refresh mechanism. This refresh mechanism is designed to minimize an entire network of ONTs 330a-330n (FIG. 3A) from requesting their respective configurations from the Configuration Server 310 at exactly the same time. Such simultaneous requesting of configurations may occur directly after a system wide power outage or software upgrade. The refresh mechanism may include a polling timer setting that may be set to either an interval or a specific time of day. Additionally, the timer setting may specify a random time window within which the ONT 331 may poll the Configuration Server 310. The refresh mechanism allows the Configuration Server 310 to use lower-cost hardware by spreading peak demand, randomly, across a time window that may be set by the user.

The Configuration Server 310 may communicate through a separate channel to retrieve additional information for a particular user, such as a specific ONT identifier for the user. This communication enhances the overall ability to provision additional information for users based on information that is already available via the EMS 350. For example, a service-provider may want to configure new services for a particular user. If the user already has other ONT (or similar) services configured via the EMS 350, the feature allows the Configuration Server 310 to retrieve all the necessary information, such as the ONT identifier, Plain Old Telephone Service (POTS), and pre-configured Service Level Agreements (SLAs), for the user from the EMS 350. This retrieval of information avoids manual entry of the several parameters for the user and, thus, avoids the inherent errors associated with manually entering such information. It should be noted that in embodiments that involve SIP networks, no SIP messaging is necessary. The Configuration Server 310 instead uses the separate communication channel to communicate SIP information.

Communications between the Configuration Server 310 and the EMS 350 may be supported by Transaction Language 1 (TL1), XML, or any other standard or proprietary communication technique. Additionally, communications may involve shared access to a database that is managed by the EMS 350.

FIG. 3C is a flow chart 370 illustrating an embodiment of the present invention. According to the example embodiment, profiles that define internode communications between nodes in a network are configured (372) and associated with at least one ONT in the network (374). Based on the associated profiles, a configuration is generated for the at least one ONT (376), which is then forwarded to the at least one ONT in response to a request from one or more of the ONTs (378).

FIG. 3D is a block diagram 380 illustrating an embodiment of the present invention. The example embodiment includes an interface 382, such as a computer terminal, for example, for configuring profiles 384 that define internode communications between nodes in a network. An association module 386 associates the profiles 384 with at least one ONT in the network. Based on the profiles 384 and the associations 388, a configuration generation module 390 generates a configuration 392 for the associated ONTs, which, in response to a request from one or more of the ONTs, is forwarded to the ONTs by a communications module 394.

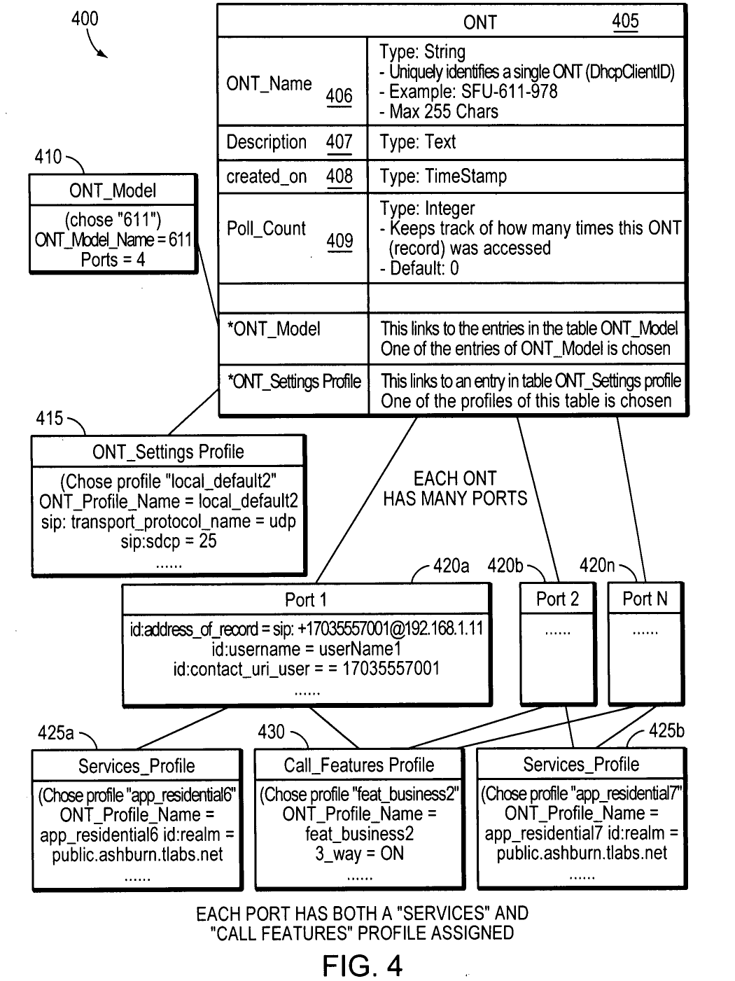

FIG. 4 is a block diagram illustrating an example Optical Network Terminal (ONT) database structure 400 for the database of FIG. 3, according to an embodiment of the present invention. An ONT 405 may include a unique name 406 (DHCP Client ID), a description 407 of the ONT 405, the date and time of creation 408, and a record of the number of times the ONT has been accessed 409. The ONT 405 may also include an ONT Model 410 (such as 611 or 612) and global settings known as ONT Settings 415. Each ONT 405 may have many ports 420a-420n, each port being associated with both Services settings 425 and Call Features settings 430.

Each port 420 may also include unique information such as its Address of Record (AOR) and contact Uniform Resource Identifier (URI). The ONT Settings 415, Services settings 425, and Call Features settings 430 may be saved into profiles and associated with an ONT 405 and its ports 420a-420n, accordingly. It should be noted that one ONT settings profile may be associated with many ONTs. Likewise, one Services profile may be associated with many ONT ports, and one Call Features profile may be associated with many ONT ports.

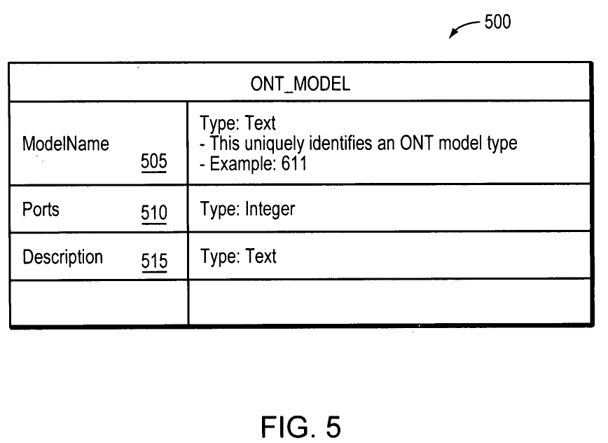

FIG. 5 is a block diagram illustrating an example Optical Network Terminal (ONT) model database structure 500, according to an embodiment of the present invention. An ONT is associated with an ONT Model, which includes a model name 505, the number of ports 510 for the model, and a description 515 of the model.

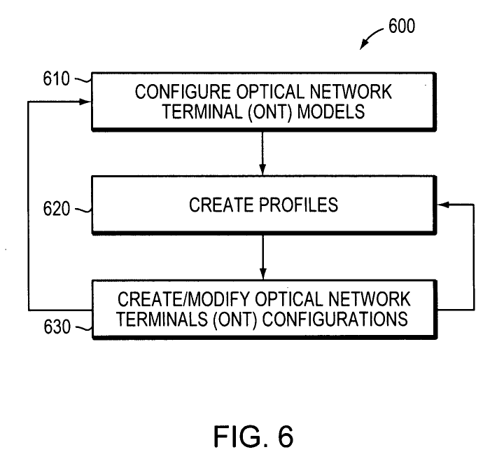

FIG. 6 is a flow chart 600 illustrating configuring Optical Network Terminals (ONTs), profiles, and ONT models, according to an embodiment of the present invention. To create or modify an ONT configuration, ONT models to be associated with a new or existing ONT configuration are configured in an example embodiment (610). Profiles to be associated with the new or existing ONT configurations are also configured in the example embodiment (620). The profiles may include general ONT Settings profiles, Services settings profiles, and Call Features settings profiles. Once ONT models and profiles have been configured, new ONT configurations may be created, or existing ONT configurations may be modified (630). When creating or modifying an ONT, the previously created ONT models and profiles are associated with the ONT in the example embodiment. It should be noted that at anytime in the above process, new ONT models and profiles may be created and existing ONT models and profiles may be modified.

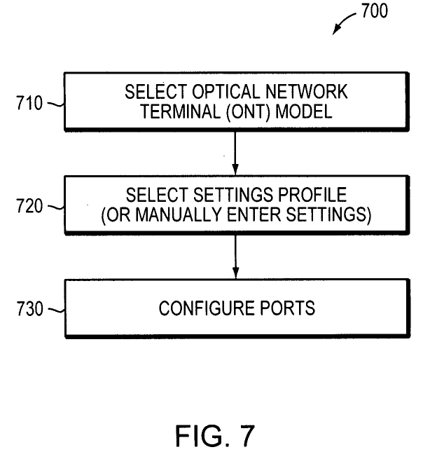

FIG. 7 is a flow chart 700 illustrating configuring Optical Network Terminals (ONTs), according to an embodiment of the present invention. To configure an ONT, an ONT model is selected (710) and an ONT Settings profile is selected or manually entered (720) according to the example embodiment of FIG. 7. Each port of the ONT is also configured in this embodiment (730).

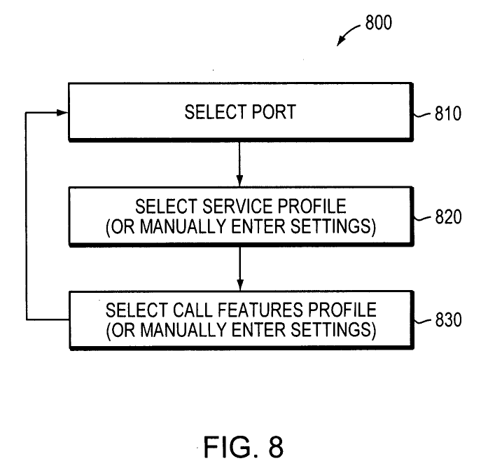

FIG. 8 is a flow chart illustrating configuring Optical Network Terminal (ONT) ports, according to an embodiment of the present invention. To configure a port of an ONT, the port to be configured is selected (810). A Services settings profile is selected or information manually entered for the selected port (820). Likewise a Call Features settings profile is selected or information manually entered for the selected port (830).

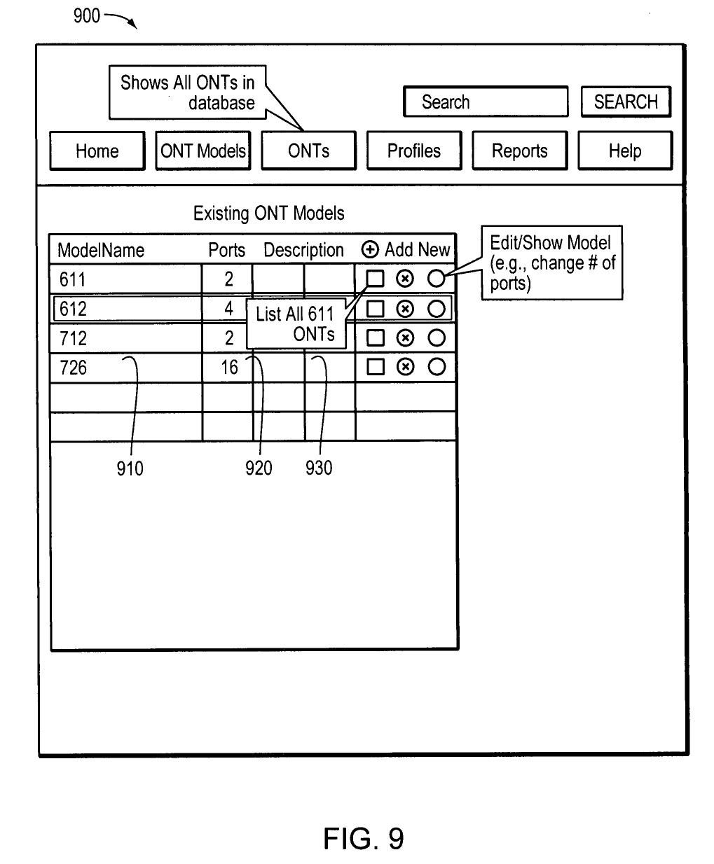

FIG. 9 is a diagram illustrating an example interface screen 900 used to configure Optical Network Terminal (ONT) models, according to an embodiment of the present invention. A user of the embodiment first populates an ONT model table 500 (FIG. 5) in a database 315c (FIG. 3) so it can be associated with a new ONT. The creation of the ONT model table may be performed manually or through a reading of a supplied data file into the database 315c (FIG. 3). Once the ONT model table is populated, the model name 910, the number of ports 920, and the model's description 930 may be displayed on the interface screen 900.

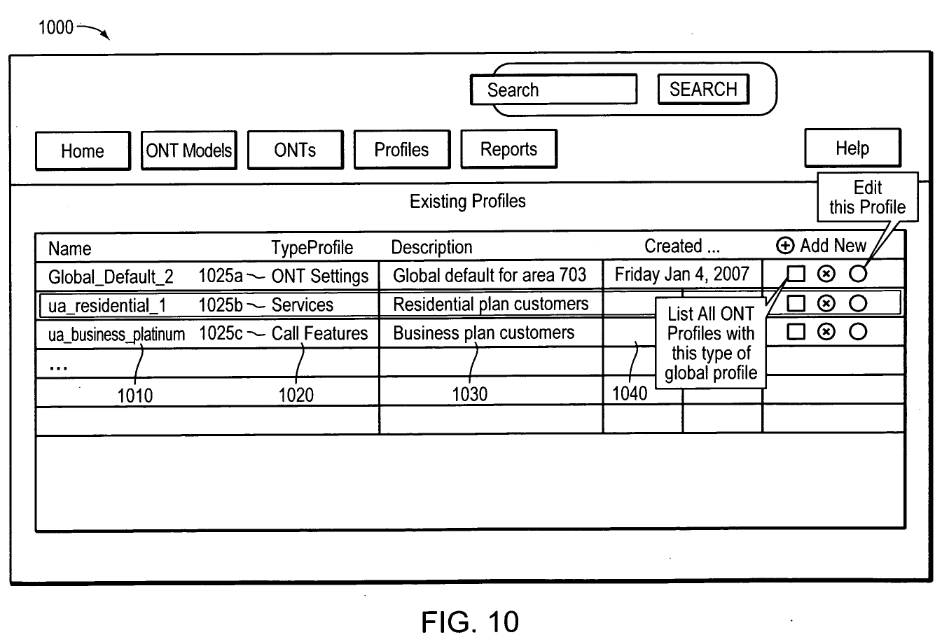

FIG. 10 is a diagram illustrating an example interface screen 1000 used to configure profiles, according to an embodiment of the present invention. A user of the embodiment creates profiles to be associated with ONTs. The profiles may include ONT Settings profiles 1025a, Services settings profiles 1025b, and Call Features setting profiles 1025c. Once the profiles are created, the profiles' names 1010, the types of profiles 1020, the profiles' descriptions 1030, and the dates of creation 1040 may be displayed on the interface screen 1000.

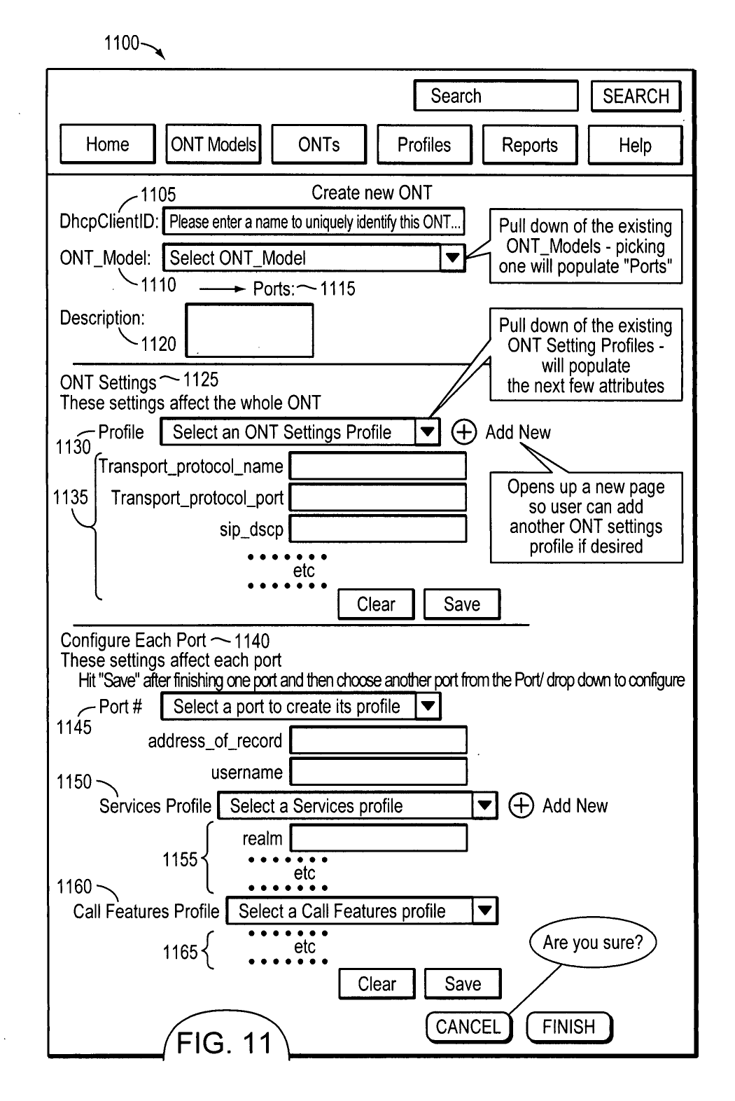

FIG. 11 is a diagram illustrating an example interface screen 1100 used to create and modify Optical Network Terminal (ONT) configurations, according to an embodiment of the present invention. When creating a new, or modifying an existing, ONT a user provides a DHCP Client Identifier 1105, and select an ONT model 1110. The DHCP Client Identifier 1105 is a unique identifier for the ONT. The ONT model 1110 may be selected from a list of ONT models retrieved from a database 315c (FIG. 3). Once the ONT Model 1110 (e.g. 611) is selected, the number of ports 1115 associated with the selected ONT model 1110 and its description 1120 is displayed.

The user may then configure the ONT settings 1125 by selecting an ONT Settings profile 1130 from a list of profiles retrieved from the database 315c (FIG. 3) or by creating custom ONT settings by manually entering the required information 1135. If the user selects an ONT profile from the list, the settings 1135 are automatically filled-in according to the selected profile.

Once the ONT Settings 1125 have been configured, the user may then configure each port 1140 of the ONT. For each port, the user selects the port number 1145 and selects both a Services settings profile 1150 and a Call Features settings profile 1160 for the selected ONT port 1145. When each profile 1150, 1160 is selected, the settings 1155, 1165 are automatically filled-in according to the selected profiles 1150, 1160. It should be noted that in lieu of selecting profiles 1150, 1160, the user may specify custom settings for the Services settings and Call Features settings by manually entering the information 1155, 1165.

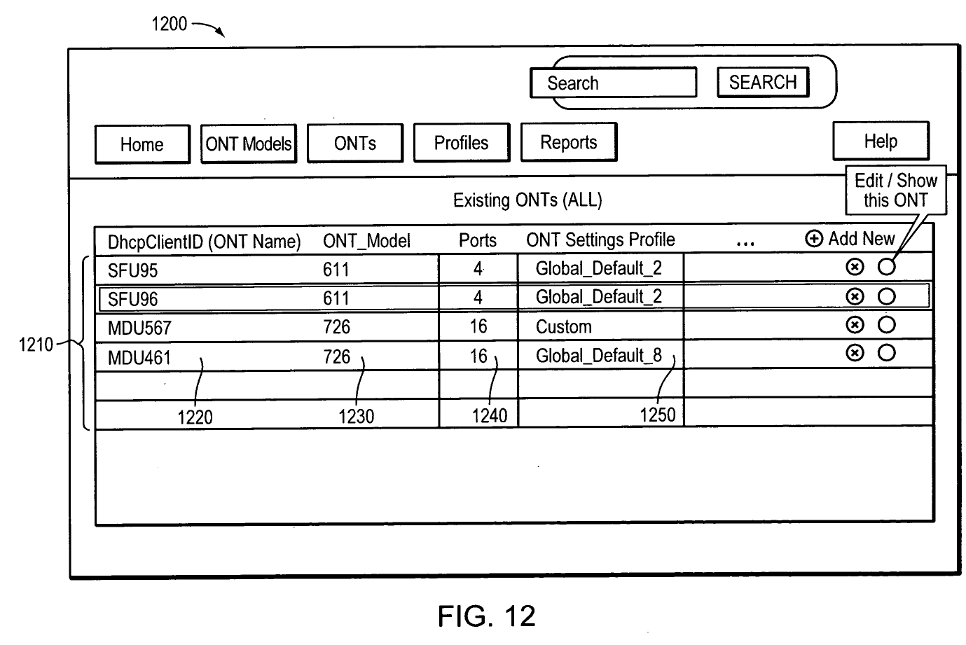

FIG. 12 is a diagram illustrating an example interface screen 1200 displaying a summary of configured Optical Network Terminal (ONT) profiles, according to an embodiment of the present invention. When at least one ONT has been configured, a summary 1210 of the ONTs including each ONT's name 1220 (DHCP Client ID), model 1230, number of ports 1240, and global settings profile 1250 may be displayed on the interface screen 1200. Additionally, information relating to the ONTs may be automatically collected, and statistics relating to the ONTs may be displayed to the user.

In addition to creating one ONT at a time, a user may create multiple ONT profiles at once. This multiple ONT creation option may clone existing profiles; however, in order for each ONT to have its own unique identifier (DHCP Client ID), a formula is specified by which each new ONT is assigned a unique identifier. An example of such a formula is as follows:

FORMULA: SFU<a>-<b>

| | | | |
|---|---|---|---|
| Define a = | start: 611 | end: 611 | increment: 0 |
| Define b = | start: 56 | end: 95 | increment: 1 |

The following is a possible resulting message displayed during the multiple ONT creation using the above formula:
Creating ONT SFU611-56
Creating ONT SFU611-57
. . .
Creating ONT SFU611-95

While this invention has been particularly shown and described with references to example embodiments thereof, it will be understood by those skilled in the art that various changes in form and details may be made therein without departing from the scope of the invention encompassed by the appended claims.

For example, the user interfaces used in configuring profiles and ONTs may include additional features, such as a sort feature that allows a user to sort elements displayed by certain attributes (e.g., sorting by the names of the profiles). An additional feature may include a search feature that allows a user to search for certain attributes (e.g., searching by profile name or address of record). Additionally, the present invention may include a feature that provides statistics and graphs relating to information stored in the Configuration Server 310 (FIG. 3) as well as a summary of a given ONT or a group of ONTs.

It should be understood that the flow diagrams of FIG. 3C and FIGS. 6-8 are examples that may include more or fewer components, be partitioned into subunits, or be implemented in different combinations. Moreover, the flow diagrams may be implemented in hardware, firmware, or software. If implemented in software, the software may be written in any software language suitable for use in systems and networks as illustrated in FIGS. 1, 2, 3A, 3B, and 3D. The software may be embodied on any form of computer readable medium, such as RAM, ROM, or magnetic or optical disk, and loaded and executed by generic or custom processor(s).

It should be noted that illustrated embodiments of some of the techniques described herein are described as using the Session Initiation Protocol (SIP). A version of the SIP protocol that may adapted for use with the techniques described herein is described in J. Rosenberg et al., “SIP: Session Initiation Protocol,” RFC 3261, June 2002, which is available from the Internet Engineering Task Force (IETF) and which is incorporated herein by reference in its entirely. It should be noted that other protocols and communication techniques may be adapted to be used with the techniques described herein.

What is claimed is:

1. A method for configuring optical network terminals (ONTs) in a network, the method comprising:
configuring at least one profile defining internode communications between nodes in a network;
associating at least one of the profiles with at least one optical network terminal (ONT) having at least one port to support internode communications between the at least one ONT and another node in the network;
generating a configuration for the at least one ONT based on the at least one profile associated with the at least one ONT; and
forwarding the configuration to at least one of the ONTs in response to a request from the at least one ONT.

2. The method of claim 1 wherein at least one of the profiles associated with the at least one ONT includes a polling timer setting, and wherein the at least one ONT requests configurations based on the polling timer setting.

3. The method of claim 2 wherein the polling timer setting specifies a time window in which the at least one ONT randomly requests its configuration.

4. The method of claim 1 wherein the at least one ONT requests its configuration in response to a new configuration alert.

5. The method of claim 1 wherein configuring the profiles includes configuring at least one settings profile, at least one services profile, and at least one call features profile, and wherein associating at least one of the profiles with at least one ONT includes for each ONT, associating one of the settings profiles with the ONT, and for each port of the ONT, associating one of the services profiles and one of the call features profiles with the port.

6. The method of claim 1 wherein the network is a session initiation protocol (SIP) network, and wherein forwarding the configuration includes forwarding the configuration without using a SIP protocol stack.

7. A system for configuring optical network terminals (ONTs) in a network, the system comprising:
an interface to configure at least one profile defining internode communications between nodes in a network;
an association module to associate at least one of the profiles with at least one optical network terminal (ONT) having at least one port to support internode communications between the at least one ONT and another node in the network;
a configuration generation module to generate a configuration for the at least one ONT based on the at least one profile associated with the at least one ONT; and
a communications module to forward the configuration to at least one of the ONTs in response to a request from the at least one ONT.

8. The system of claim 7 wherein at least one of the profiles associated with the at least one ONT includes a polling timer setting, and wherein the at least one ONT requests configurations based on the polling timer setting.

9. The system of claim 8 wherein the polling timer setting specifies a time window in which the at least one ONT randomly requests its configuration.

10. The system of claim 7 further comprising an element management system (EMS) to alert at least one of the ONTs that a new configuration is available, and wherein at least one of the ONTs requests its configuration in response to the alert.

11. The system of claim 7 wherein the at least one profile includes at least one settings profile, at least one services profile, and at least one call features profile, and wherein the association module, for each ONT, associates one of the settings profiles with the ONT, and for each port of the ONT, associates one of the services profiles and one of the call features profiles with the port.

12. The system of claim 7 wherein the interface is a web browser.

13. A network for configuring optical network terminals (ONTs), the system comprising:
an interface to configure at least one profile defining internode communications between nodes in the network; and
a server to associate at least one of the profiles with at least one optical network terminal (ONT) having at least one port to support internode communications between the at least one ONT and another node in the network, generate a configuration for the at least one ONT based on the at least one profile associated with the at least one ONT, and forward the configuration to at least one of the ONTs in response to a request from the at least one ONT.

14. The network of claim 13 wherein at least one of the profiles associated with the at least one ONT includes a polling timer setting, and wherein the at least one ONT requests configurations based on the polling timer setting.

15. The network of claim 14 wherein the polling timer setting specifies a time window in which the at least one ONT randomly requests its configuration.

16. The network of claim 13 further comprising an element management system (EMS) to alert at least one of the ONTs that a new configuration is available, and wherein at least one of the ONTs requests its configuration in response to the alert.

17. The network of claim 13 wherein the at least one profile includes at least one settings profile, at least one services profile, and at least one call features profile, and wherein the server, for each ONT, associates one of the settings profiles with the ONT, and for each port of the ONT, associates one of the services profiles and one of the call features profiles with the port.

18. The network of claim 13 wherein the interface is a web browser and the server includes a web service.

19. An optical network terminal (ONT) in a network, the optical network terminal comprising:
at least one port to support internode communications between the optical network terminal (ONT) and another network node in a network;
a configuration based on at least one profile defining internode communications between nodes in the network; and
a polling mechanism to request new configurations.

20. The optical network terminal of claim 19 wherein the configuration includes a timer setting for the polling mechanism.

21. The optical network terminal of claim 20 wherein the timer setting specifies a time window in which the polling mechanism randomly requests a new configuration.
